(19) United States
(12) Patent Application Publication
(10) Pub. No.: US 2016/0067742 A1
(43) Pub. Date: Mar. 10, 2016

(54) Proceeding for Impregnation of Sheets of Stones and a Device to Accomplish told Proceeding

(71) Applicant: NATSTONE AB, Göteborg (SE)

(72) Inventor: Jan-Inge Lindeberg, Styrsö (SE)

(73) Assignee: Natstone AB, Göteborg (SE)

(21) Appl. No.: 14/785,713

(22) PCT Filed: Apr. 22, 2014
(86) PCT No.: PCT/SE2014/050479

§ 371 Date: Oct. 20, 2015

(30) Foreign Application Priority Data
Apr. 23, 2013 (SE) 1350499-8

(51) Int. Cl. B05D 3/04; B05B 13/02; B05D 3/06; C04B 41/50

(52) U.S. Cl. CPC B05D 3/0493; C04B 41/5024; B05B 13/02; B05D 3/06

(57) ABSTRACT

Processes for impregnating sheets of stone, concrete, or similar material with an impregnating liquid are disclosed. An impregnating liquid in spray form is injected in a vacuum chamber, in which sheets are received, at an amount that gives saturation of the sheets. Apparatus for accomplishing the processes are also disclosed.

The present invention concerns, on one hand, a proceeding for the impregnation of sheets of stone, concrete or another similar material by impregnating liquid and, on the other hand, a device to accomplish said proceeding.

It is previously known to have stone impregnated in order to get the stone stronger as well as increase its flexibility so that, among other things, it will be safe to machine the stone at later stages of its preparation. In that connection, the impregnation has been made by immersing stone sheets in impregnating agent of suitable type and then also by pressure impregnation. However, in such pressure impregnation, a large amount of impregnating liquid is consumed and then remaining impregnating liquid has to be discarded since it solidified in the container in which it was stored.

Examples of such impregnation are seen in, among others, WO94/00651 A1.

According to US 2009/0233078A1, it is seen in cited paragraphs (0025) and (0028) therein that after the stone (2) has been placed in the vacuum chamber (1), the colouring solution (3) is applied by, for instance, spraying. Next, the vacuum chamber (1) is closed, whereupon it is emptied of air through a nozzle (4) connected to a vacuum pump. In doing so, the nozzle (4) is tightly connected to the stone (2) so that the air removed from the interior of the chamber (1) is forced to pass through the pores of the stone (2). Thereby, the colouring solution (3), which is in contact with the surface of the stone (2), is entrained. Thus, the colouring is got to be brought from one side of the stone to its other side and thereby ink the stone. It is, in that connection, possible to heat the stone (2) for speeding up the dyeing proceeding.

The main object of the present invention is primarily to find a proceeding that, among other things, economizes on the impregnating liquid and efficiently provides impregnation of said sheets of stone material or the like material.

Said object is achieved by means of a proceeding according to the present invention, which essentially is characterized in that, in a vacuum chamber in which the stone sheets in question are received, there is attained stress relief of the same, that the impregnating liquid is injected in spray form at an amount that gives saturation of said stone sheets, that the sheets are allowed to remain in said vacuum chamber for at least 30 min, whereupon the impregnated sheets are dried using IR after the application of the impregnating liquid.

According to the above-mentioned US 2009/0233078 A1, there is proceeded, in contrast to the cited known method and device, in the opposite way according to the present invention.

A further object of the invention is to provide a device that efficiently facilitates said impregnation of the stone sheets, etc.

Said further object is achieved by means of a device according to the present invention, which essentially is characterized in that a vacuum chamber comprises supplying means for injecting impregnating liquid in spray form to the receiving space of said vacuum chamber for the sheets as well as means for providing vacuum therein, and that a dryer in the form of IR tubes is comprised in said vacuum chamber or in the subsequent space outside said vacuum chamber.

The invention is described in more detail below, reference being made to the appended drawings, in which

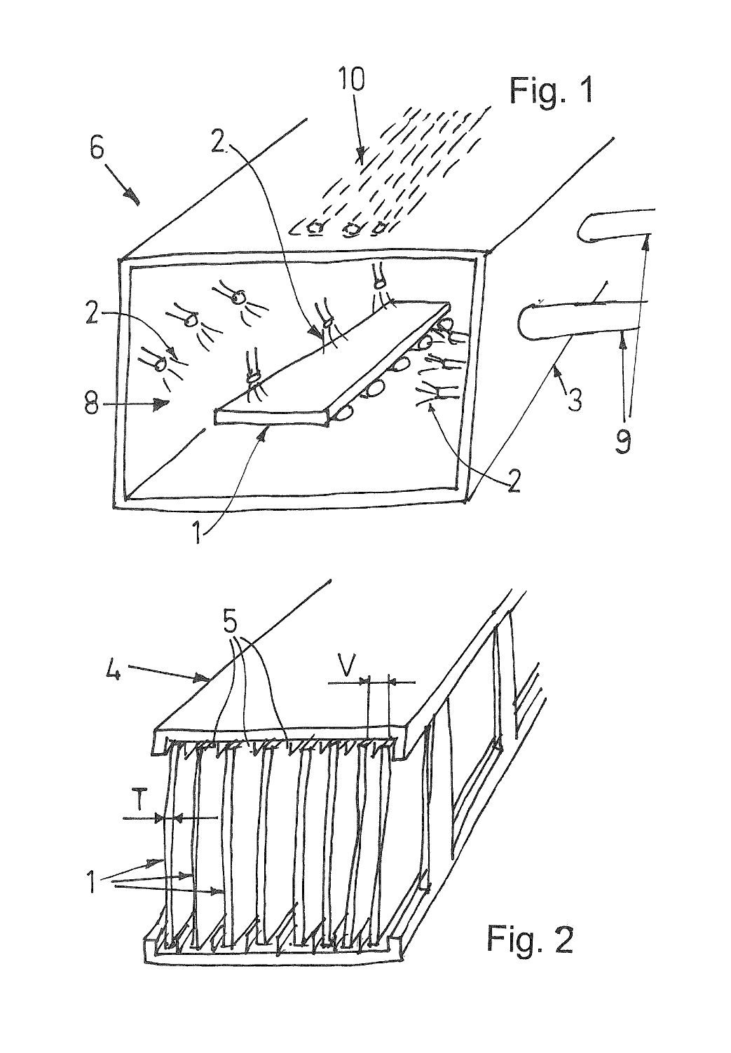

FIG. 1 shows in perspective a part of a vacuum chamber intended for the treatment of stone sheets, and

FIG. 2 shows a part of a cassette for supporting the stone sheets during the impregnating proceeding and as seen obliquely from the front.

In order to increase the durability primarily for sawn stone sheets 1, but also other sheets of concrete or another similar material before the subsequent tough polishing work, but also for the sheets to be strong and durable in use, a proceeding is utilized according to the present invention for the impregnation of such sheets 1 by impregnating liquid 2, which means application of impregnating liquid in a certain way and under certain conditions.

More precisely, the impregnating liquid 2 in question is injected in spray form in a vacuum chamber 3, in which the stone sheets in question are received. The impregnating liquid 2 is supplied at an amount that gives saturation of said stone sheets 1. There is evaporated silicate liquid 2 comprising surface tension medium, which removes the surface tension of the liquid 2 in question, and is it calculated so that the saturation becomes acceptable, and that impregnation in room temperature of between approx. 20-25° C. in the vacuum chamber 3 is allowed.

Thanks to the stress relief, which is attained thanks to the vacuum in said vacuum chamber 3, the impregnation works efficiently and with little wastage of the impregnating liquid 2. By measuring the amount of impregnating agent 2 supplied into the chamber 3 in spray form in the form of a vapour cloud, the proper amount is obtained for correct number of sheets 1, whereby the wastage of the impregnating liquid decreases essentially. The sheets 1 are allowed to remain in said vacuum chamber 3 for at least 30 min, whereupon the sheets 1 are dried by means of IR after the application of the impregnating liquid 2 onto the stone sheets 1 in the chamber 3.

The effect of the present invention is that, by the stress relief of thin stone sheets 1 and which is attained thanks to the vacuum in said vacuum chamber 3, said impregnation works efficiently and with little wastage of impregnating liquid 2.

Thus, by allowing the impregnated sheets 1 remain in said vacuum chamber 3 for at least 30 min and allowing them dry by means of IR, efficient impregnation of said stone sheets 1 is attained. Efficient holding of the stone sheets 1 during the time they are in the vacuum chamber 3, at least for the impregnation but preferably also during the drying of the sheets 1 therein or in the subsequent space therefor, is provided by said sheets 1 being held in a cassette 4 arranged and intended therefor. Said stone sheets, which have a suitably selected length and width, have preferably a thickness T of approx. 4 mm. Therefore, the cassette 4 has a number of compartments 5 having a width V of a dimension adapted to the thickness T of the sheets.

A device 6, which is suitable to accomplish said proceeding for efficient impregnation of sheets 1 consisting of natural stone or of concrete or another similar material by an impregnating liquid 2, comprises a vacuum chamber 3, which is provided with supplying means 7, for example spray nozzles, which are arranged for injecting the impregnating liquid 2 in spray form to the internal receiving space 8 of said vacuum chamber for the sheets 1 as well as means 9 for providing vacuum therein.

Supplying means for the injection of the impregnating agent 2 is in the form of a feed pump, which, however, is not shown in the drawings but which is of known type.

Dryer 10 for drying the sheets 1 from superfluous impregnating liquid 2 is in the form of a number of IR tubes 10, i.e., tubes working with infrared radiation of known type, which are comprised in, for instance, the ceiling of said impregnation chamber 3 or in the subsequent space outside said chamber 3, as seen in the movement of the sheets in the line.

A cassette 4, which can be transported into and out of, respectively, a chamber 3 in question is arranged with a number of compartments 5 intended for the receipt of the desired number of sheets 1 therein, during the time the sheets 1 are impregnated and dried according to the above.

The function and nature of the proceeding and the device should clearly have been seen from what is described above and shown in the drawings.

The invention is naturally not limited to the embodiments described above and shown in the accompanying drawings. Modifications are feasible, particularly as for the nature of the different parts, or by using an equivalent technique, without departing from the protection area of the invention, such as it is defined in the claims.

1.-7. (canceled)

8. A process for impregnating sheets of stone, concrete, or similar material with an impregnating liquid, comprising:
in a vacuum chamber, stress-relieving at least one sheet received in the vacuum chamber, injecting the impregnating liquid in spray form at an amount that yields saturation of the at least one sheet, and retaining the at least one sheet in the vacuum chamber for at least 30 minutes, thereby forming at least one impregnated sheet; and
drying the at least one impregnated sheet.

9. The process of claim 8, wherein the at least one sheet has a thickness of about 4 millimeters, and the at least one sheet is held in a cassette while the at least one sheet is in the vacuum chamber.

10. The process of claim 8, wherein the at least one sheet is at room temperature.

11. The process of claim 8, wherein the impregnating liquid is a silicate liquid.

12. The process of claim 11, wherein the at least one sheet has a thickness of about 4 millimeters, and the at least one sheet is held in a cassette while the at least one sheet is in the vacuum chamber.

13. The process of claim 12, wherein the at least one sheet is at room temperature.

14. The process of claim 13, wherein the at least one sheet has a thickness of about 4 millimeters, and the at least one sheet is held in a cassette while the at least one sheet is in the vacuum chamber.

15. An apparatus for performing the process for impregnating sheets of stone, concrete, or similar material with an impregnating liquid according to claim 8, comprising:
a vacuum chamber having an injector configured to inject the impregnating liquid in spray form onto at least one sheet received in the vacuum chamber; and
a dryer configured to dry the at least one impregnated sheet.

16. The apparatus of claim 15, wherein the vacuum chamber includes a cassette having at least one compartment for the at least one sheet received in the vacuum chamber.

17. The apparatus of claim 15, wherein the injector includes a feed pump.

18. The apparatus of claim 17, wherein the vacuum chamber includes a cassette having at least one compartment for the at least one sheet received in the vacuum chamber.
